(19) United States
(12) Patent Application Publication
(10) Pub. No.: US 2021/0106161 A1
(43) Pub. Date: Apr. 15, 2021

(54) AUTOMATIC SPILL-PROOF LID

(71) Applicant: GUANGDONG EKA INDUSTRIAL INVESTMENT CO., LTD, Guangdong (CN)

(72) Inventors: Geng SU, Guangdong (CN); Yue LIN, Guangdong (CN); Wei CAI, Guangdong (CN)

(73) Assignee: GUANGDONG EKA INDUSTRIAL INVESTMENT CO., LTD, Guangdong (CN)

(21) Appl. No.: 17/013,865

(22) Filed: Sep. 8, 2020

(30) Foreign Application Priority Data
Oct. 12, 2019 (CN) 201910969840.1

(51) Int. Cl. A47J 27/56; A47J 36/06; A47J 36/38

(52) U.S. Cl. CPC A47J 27/56; A47J 36/38; A47J 36/06

(57) ABSTRACT

The present invention provides an automatic spill-proof lid, comprising a pot lid and a blocking lid. The blocking lid is connected to the pot lid. The pot lid has exhaust ports corresponding to a position directly below the pot lid and an air storage space is formed between the blocking lid and the pot lid. When in use, the blocking lid is deformed by an impact of air pressure discharged from the exhaust ports, so that a passage connecting the air storage space between the blocking lid and the pot lid to outside becomes larger.

### CROSS-REFERENCE TO RELATED APPLICATION

This application claims the priority benefit of China application serial no. 201910969840.1, filed on Oct. 12, 2019. The entirety of the above-mentioned patent application is hereby incorporated by reference herein and made a part of this specification.

### BACKGROUND

### Technical Field

The present invention relates to the technical field of cooking tools, and more particularly, to an automatic spill-proof lid.

### Description of Related Art

Usually when people heat soup, porridge, dairy products and other viscous liquids, if they are unattended and cover a lid, the liquids in a pot will usually spill out of the pot, there is a danger of extinguishing fire and letting gas leak. If you don't cover the lid, you will lose a lot of heat during a cooking process, resulting in wasted energy, longer cooking time, and uneven heating of food in the pot, which will affect the quality of the food.

Therefore, some spill-proof lids have appeared on the market, but spill-proof effects of existing spill-proof lids are not satisfying. For example, an existing spill-proof lid includes one pot lid recessed from edges toward a central part. The central part of the pot lid has one opening, and spilled liquids flow back into a container through the opening after being cooled by contact with the external cold air, to realize a spill-proof function. However, the spill-proof lid has problems such as poor heat preservation effect when not boiling, waste of energy and time, and uneven heating of food.

There is also a spill-proof lid, which includes one pot lid recessed from edges toward a central part and a blocking lid. The pot lid is provided with an exhaust port for discharging air and boiling liquids in the pot. The blocking lid is connected to the pot lid. The blocking lid is provided with a blade, which is used to block the exhaust port on the pot lid. Before use, first rotate the blocking lid, so that the blade on the blocking lid is closed with the exhaust port on the pot lid, or directly open the blade on the blocking lid, but the heat preservation effect is poor. When food in the pot is boiling and an exhaust space needs to be increased, it is necessary to manually rotate the blocking lid to stagger the blade and the exhaust port. The exhaust port is fully open for rapid exhaust, but there is a risk of being scalded by steam and boiling liquids.

### SUMMARY

In view of at least one deficiency of the prior art, an object of the present invention is to provide an automatic spill-proof lid that realizes automatic spill-proof.

In order to achieve the above object, a technical solution provided by the present invention is: an automatic spill-proof lid, including a pot lid and a blocking lid. The pot lid is provided with exhaust ports. The blocking lid is provided on an upper side of the pot lid corresponding to the exhaust ports. The blocking lid is connected to the pot lid, and an air storage space is formed between the blocking lid and the pot lid. When in use, the blocking lid is deformed by an impact of air pressure discharged from the exhaust ports, so that a passage connecting the air storage space between the blocking lid and the pot lid to outside becomes larger.

The spill-proof lid is placed on a rim of the pot. In an early stage of heating, the blocking lid is placed on an upper side of the exhaust ports, and the exhaust ports are almost in a closed state, which have a heat preservation effect. As temperature increases, pressure in the pot gradually increases. High-pressure steam in the pot discharges from the exhaust ports and impacts the blocking lid, resulting in the blocking lid is automatically deformed upwards by a steam impact force, so that the air storage space between the blocking lid and the pot lid is opened. The exhaust ports of the pot lid become open, which makes the passage between the air storage space and the outside larger and facilitates a rapid discharge of steam in the pot. Boiling liquids contact cold air outside the pot no longer climbs, so that the liquids stay in the pot, so as to achieve the automatic spill-proof effect. No human operation is required, thus avoiding being scalded by the steam.

Further, the blocking lid is connected to a central part of the pot lid, the exhaust ports are provided in a surrounding area of the pot lid corresponding to a connecting part of the blocking lid and the pot lid, and the blocking lid is located above all exhaust ports. Under the impact of the steam discharged from surrounding exhaust ports, resulting in surroundings of the blocking lid are deformed upwards, so that the steam in the pot can be quickly discharged from the surrounding exhaust ports.

Further, the pot lid includes a main body of the pot lid and an exhaust seat. The exhaust seat is provided in a central part of the main body of the pot lid and its height increases from an edge to the central part. A central part of the blocking lid is connected to a central part of the exhaust seat. The exhaust ports are provided on the exhaust seat in the surrounding area corresponding to the connection part of the blocking lid and the exhaust seat. Sides of the exhaust seat form slopes, which can prevent spilled liquids from accumulating on the exhaust seat, increasing a surface burden and easily causing collapse.

Further, the main body of the pot lid is a concave ring structure whose height decreases from an outer edge to the central part, a lower edge of the exhaust seat is connected to an inner edge of the main body of the pot lid, and all the exhaust ports extend to a lowest position of the main body of the pot lid, so that the spilled boiling liquids fully contact with the external cold air to condense and return from the exhaust ports to the pot.

Further, the exhaust ports are evenly distributed on the exhaust seat, so that the surrounding area of the blocking lid is uniformly affected by the steam impact force of the exhaust ports and deforms upwards steadily, so that the steam in the pot is quickly discharged.

Further, a bottom surface of the main body of the pot lid is provided with a plurality of snap rings of the rim of the pot with different diameters, so as to adapt to use with pots of different diameters.

Further, the blocking lid is a bowl-shaped structure, and the central part of the blocking lid and the central part of the exhaust seat are detachably connected. When the blocking lid is impacted by the air pressure discharged from the exhaust ports, a rim of a bowl of the blocking lid is changed from facing downwards to facing upwards, so that a distance between an edge of the blocking lid and the main body of the pot lid becomes larger, so that the passage connecting the air storage space between the blocking lid and the pot lid to outside becomes larger. When the rim of the bowl of the blocking lid is facing downwards, the edge of the blocking lid is in contact with an upper side of the main body of the pot lid, and all the exhaust ports are located in an area directly under the blocking lid to enhance the heat preservation effect. The air storage space has a larger storage pressure to ensure that the pressure in the air storage space is large enough to cause the blocking lid to deform from the rim of the bowl of the blocking lid facing downwards to facing upwards, thereby increasing the exhaust passage to achieve spill-proof.

Further, the blocking lid includes a non-deformed central part and a deformed peripheral part located around the non-deformed central part. A connecting part between the non-deformed central part and the deformed peripheral part is provided with a groove to make it easier for the deformed peripheral part of the blocking lid to be folded and deformed. An outer edge of the deformed peripheral part has a reinforced convex ring. By providing the reinforced convex ring, since the strength of the reinforced convex ring is greater than the strength of the deformed peripheral part, when the blocking lid is deformed from the rim of the bowl of the blocking lid facing downwards to facing upwards due to the impact of the air pressure in the pot, the reinforced convex ring can ensure that the blocking lid remains current shape. It is not easy to restore the previous shape without applying other external forces, which is helpful to keep the exhaust ports open.

In another solution, a thickness of the deformed peripheral part gradually increases from a central part to an edge, so that the strength of the edge position of the deformed peripheral part are large, and it can also ensure that the blocking lid maintains the current shape without external forces.

Furthermore, in order to facilitate the assembly of the blocking lid and the exhaust seat, a central part of a lower side of the blocking lid is provided with a connecting pillar, and the central part of the exhaust seat is provided with a connecting hole cooperating with the connecting pillar. The blocking lid is inserted into the connection hole of the exhaust seat through its connection pillar, and preferably the connection pillar and the connection hole are interference fit.

Further, a retaining ring is provided at a lower end of the connecting pillar, and a diameter of the retaining ring is larger than a diameter of the connecting hole, so as to prevent the connecting pillar from automatically detaching from the connecting hole.

Further, in order to facilitate lifting of the blocking lid, a handle is also provided on the upper side of the blocking lid.

In another solution, the central part of the exhaust seat is provided with a connecting strip, and a connecting snap hole is provided in the central part of the blocking lid. An upper end of the connecting strip is provided with two snap rings at a certain distance, diameters of the snap rings are larger than a diameter of the connecting snap hole. The upper end of the connecting strip is sleeved into the connecting snap hole, and the two snap rings are respectively located at the edges of the holes at both ends of the connecting snap hole, so that the blocking lid is not easily separated from the connecting strip.

In the present invention, a bowl-shaped blocking lid that the rim of the bowl can face downwards and upwards is provided above the exhaust ports. When the rim of the bowl of the blocking lid faces downwards, the blocking lid and the pot lid form a closed air storage space, and the exhaust ports are not connected to the outside, which effectively keeps the pot warm. During the process of cooking food, as temperature in the pot increases, the blocking lid is automatically deformed from the rim of the bowl facing downwards to facing upwards by the high-pressure steam in the pot. At this time, the air storage space between the blocking lid and the pot lid is opened, so that the passage connecting the air storage space between the blocking lid and the pot lid to outside becomes larger. It is no need for manual operation to increase the exhaust space, and avoiding manual operation being scalded by steam and boiling liquids. The boiling liquids spilling from the exhaust ports is in full contact with the external cold air and then condense and automatically flows back into the pot from the exhaust ports. Even if there are no personnel to guard, the liquids will not spill to the outside of the pot.

### BRIEF DESCRIPTION OF THE DRAWINGS

FIG. 1 is a schematic view of a spill-proof lid in a closed state according to an embodiment of the present invention.

FIG. 2 is a cross-sectional view taken along line A-A in FIG. 1.

FIG. 3 is a schematic view of a spill-proof lid in an opened state according to an embodiment of the present invention.

FIG. 4 is a cross-sectional view taken along line B-B in FIG. 3.

FIG. 5 is an exploded schematic view of a spill-proof lid according to an embodiment of the invention.

FIG. 6 is a schematic structural view of a lower side of a spill-proof lid according to an embodiment of the present invention.

FIG. 7 is an enlarged view of part C in FIG. 4.

FIG. 8 and FIG. 9 are schematic views of front and back surfaces of a blocking lid in a closed state according to an embodiment of the present invention.

FIG. 10 is a cross-sectional view of a blocking lid in a closed state according to an embodiment of the present invention.

FIG. 11 is a schematic structural view of a blocking lid in an opened state according to an embodiment of the present invention.

FIG. 12 is a cross-sectional view of a blocking lid in an opened state according to an embodiment of the present invention.

### DESCRIPTION OF THE EMBODIMENTS

The present invention will be further described below with reference to the drawings. The drawings are for illustrative purposes only, and should not be construed as limiting the present invention.

In order to explain embodiments more succinctly, some parts known in the drawings or description but not related to the main content of the present invention will be omitted. In addition, for ease of expression, some parts in the drawings may be omitted, enlarged or reduced, but does not represent the actual product size or the entire structure.

### Embodiment 1

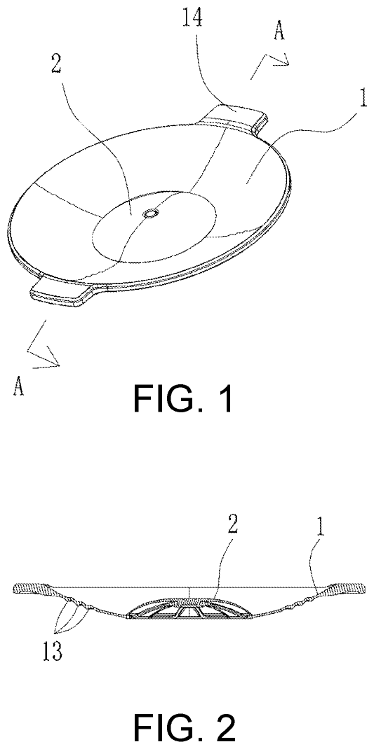

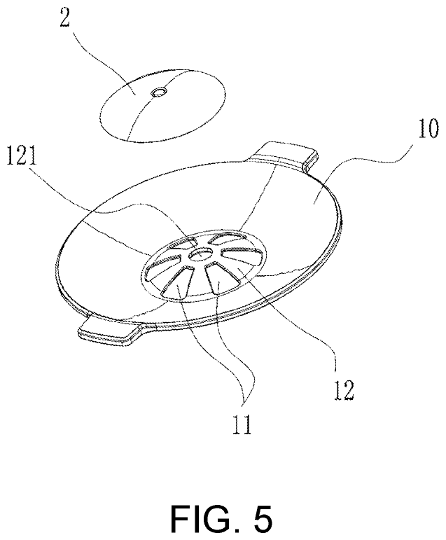

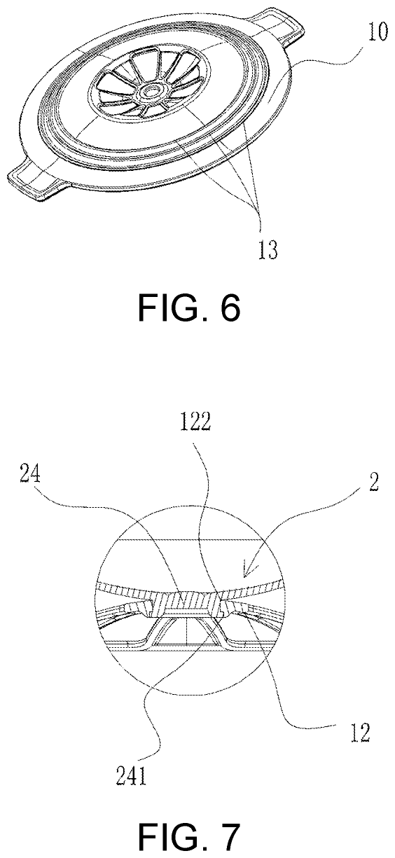

As shown in FIGS. 1-6, this embodiment provides an automatic spill-proof lid, including a pot lid 1 and a blocking lid 2, wherein the pot lid 1 is similar to a circular disc-shaped structure, and the blocking lid 2 is a bowl-shaped structure. Under an action of an external force, a rim of a bowl of the blocking lid 2 can be deformed by switching between facing downwards and facing upwards. A central part of the pot lid 1 is provided with a plurality of exhaust ports 11 arranged in a circle. A lower side of a central part of the blocking lid 2 is connected to a central of the pot lid 1. When the rim of the bowl of the blocking lid 2 faces downwards, the blocking lid 2 is covered on an upper side of all the exhaust ports 11, and an edge of the blocking lid 2 is in contact with an upper side of a main body 10 of the pot lid, so that a closed air storage space is formed between the blocking lid 2 and the pot lid 1.

When in use, the spill-proof lid is placed on a rim of the pot. In the early stage of heating, the rim of the bowl of the blocking lid 2 faces downwards and the blocking lid 2 is covered on the upper side of the exhaust ports 11. The exhaust ports 11 can only communicate with the air storage space between the blocking lid 2 and the pot lid 1, and can hardly communicate with outside, which is equivalent to the exhaust ports 11 being in a closed state, which have a better heat preservation effect. However, as the temperature rises, the pressure in the pot gradually increases, and steam and boiling liquids impact the pot lid 1 and the blocking lid 2. The blocking lid 2 is automatically deformed from the rim of the bowl facing downwards to facing upwards by the pressure generated by the steam and boiling liquids discharged from the exhaust ports 11. At this time, the air storage space between the blocking lid 2 and the pot lid 1 is opened, resulting in a distance between the edge of the blocking lid 2 and the pot lid 1 becomes larger, so that the passage connecting the air storage space between the blocking lid 2 and the pot lid 1 to outside becomes larger. It can increase the exhaust space without manual operation; and avoid being scalded by steam and boiling liquids. At this time, the steam in the pot can be quickly discharged, and the boiling liquids contact the cold air outside the pot and no longer rise, so that the liquids stays in the pot, so as to achieve the effect of automatic spill-proof.

As a preferred embodiment, the pot lid 1 includes a main body 10 of the pot lid and an exhaust seat 12. Wherein, the main body 10 of the pot lid is a concave ring structure whose height decreases from an outer edge to a central part. A lower surface of the main body 10 of the pot lid is provided with a plurality of snap rings 13 of the rim of the pot with collinear centers and different diameters. A center of the snap rings 13 of the rim of the pot is collinear with a center of the main body 10 of the pot lid. The exhaust seat 12 is a convex structure whose height gradually increases from an edge to a central part. A lower edge of the exhaust seat 12 is connected to an inner edge of the main body 10 of the pot lid. The exhaust seat 12 protrudes toward the upper side of the main body 10 of the pot lid, and the lower side of the central part of the blocking lid 2 is connected to a central part of a top of the exhaust seat 12. The exhaust ports 11 are provided on the exhaust seat 12 in a circumferential area corresponding to a connecting part of the blocking lid 2 and the exhaust seat 12, and ends of all the exhaust ports 11 near the main body 10 of the pot lid extend to a lowest position of the main body 10 of the pot lid. When the rim of the bowl of the blocking lid 2 faces downwards, the blocking lid 2 is covered on the upper side of all the exhaust ports 11, that is, all the exhaust ports 11 are located in the area covered by the blocking lid 2. In this way, the heat preservation effect is the best, and the rim of the bowl of the blocking lid 2 is relatively easy to deform upwards. Of course, a small part of the exhaust ports 11 can also be exposed to the outside of the blocking lid 2, but this has a poor heat preservation effect, and when the temperature in the pot is high enough and the air pressure is high enough, the blocking lid 2 can also be deformed with the rim of the bowl facing upwards to achieve the effect of exhaust. The snap rings 13 of the rim of the pot of different diameters can be used in conjunction with pots of different calibers to improve the versatility of the spill-proof lid. Two opposite sides of the outer edge of the pot lid 1 are respectively provided with handles 14 to facilitate the lifting and movement of the pot lid 1.

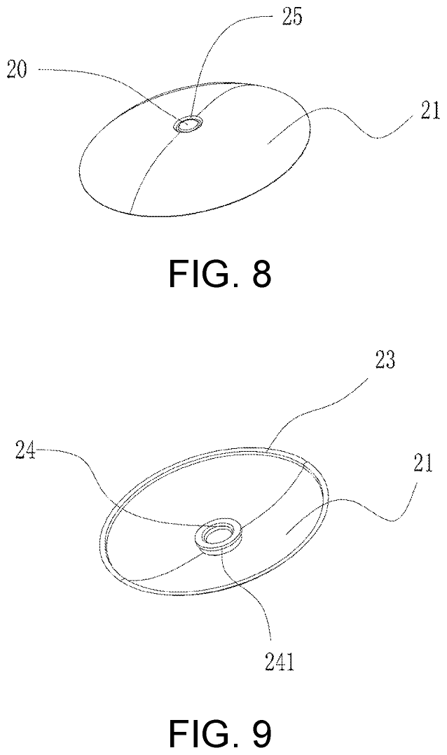

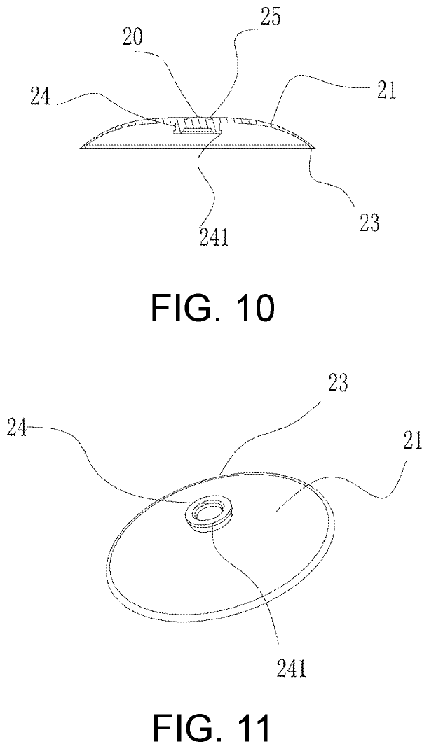

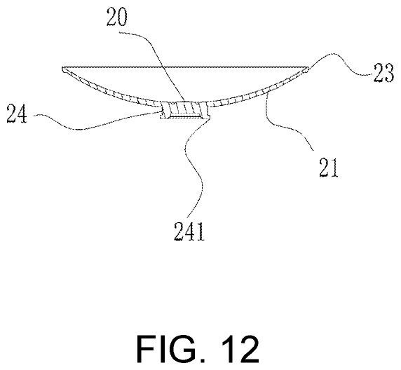

As shown in FIGS. 7 to 12, the blocking lid 2 shown includes a non-deformed central part 20 and a deformed peripheral part 21 located around the non-deformed central part 20. In this embodiment, it is preferable that the deformed peripheral part 21 and the non-deformed central part 20 are integrally formed of the same material, for example, made of silica gel. Of course, the deformed peripheral part 21 and the non-deformed central part 20 can also be formed by splicing of different materials. However, the strength of the non-deformed central part 20 is greater than that of the deformed peripheral part 21. The thickness of the non-deformed central part 20 can be increased, and the thickness of the deformed peripheral part 21 is relatively small, resulting in the deformed peripheral part 21 is relatively soft, so that the deformed peripheral part 21 is easily deformed by the external force. The deformed peripheral part 21 is equivalent to a side wall of the bowl of the blocking lid 2, the non-deformed central part 20 is equivalent to a bottom of the bowl of the blocking lid 2, and an edge of the deformed peripheral part 21 forms the rim of the bowl of the blocking lid 2. The lower side of the blocking lid 2 is provided with a connecting pillar 24 at a position corresponding to the non-deformed central part 20, and the connecting pillar 24 is also preferably integrally formed with the blocking lid 2. The central part of the top of the exhaust seat 12 is provided with a connecting hole 121 that is in interference fit with the connecting pillar 24. When assembling, the blocking lid 2 is inserted into the connecting hole 121 of the exhaust seat 12 through its connecting pillar 24. If you need to clean the blocking lid 2, it can directly pull the connecting pillar 24 from the connection hole 121 to take out the blocking lid 2. The upper side of the blocking lid 2 is also provided with a handle (not shown in the figure), which is convenient for lifting the blocking lid 2 or assembling the blocking lid 2 with the pot lid 1. When the air pressure in the pot gradually increases, causing the air pressure in the air storage space between the blocking lid 2 and the pot lid 1 to reach a certain level, the deformed peripheral part 21 will deform from the rim of the bowl facing downwards to facing upwards. The air storage space is greatly opened, and the steam in the pot is quickly discharged from the exhaust ports 11 to the outside.

In addition, a connection part of the non-deformed central part 20 and the deformed peripheral part 21 is provided with one annular groove 25, so that the strength of the connecting part of the non-deformed central part 20 and the deformed peripheral part 21 is weakened. It is beneficial for the deformed peripheral part 21 to be folded relative to the non-deformed central part 20, so that the orientation of the rim of the bowl of the blocking lid 2 can be changed more easily.

The deformed peripheral part 21 of the blocking lid 2 of this embodiment can be automatically deformed from the rim of the bowl facing downwards to facing upwards through affecting by the pressure discharged from the pot, or this deformation can be realized manually to open the air storage space for exhaust. The specific operation is: press the central part of the non-deformed central part 20 by hand; and an edge of an upper hole of the connecting hole 121 at the top of the exhaust seat 12 forms a fulcrum 122. As the non-deformed central part 20 is forced toward the connecting hole 121 of the exhaust seat 12 to deform downwards and move downwards. However, the deformed peripheral part 21 cannot move downwards because it is blocked by the fulcrum 122. At this time, the deformed peripheral part 21 will receive a reaction force at the fulcrum 122 and bend upwards, causing the deformed peripheral part 21 to fold, and this causes the deformation of the deformed peripheral part 21 to change from the rim of the bowl facing downwards to facing upwards, so that the blocking lid 2 can be manually opened for exhaust.

As an improvement of the above solution, an outer edge of the deformed peripheral part 21 is provided with a reinforced convex ring 23. The reinforced convex ring 23 can be arranged on either side of the outer edge of the deformed peripheral part 21. The reinforced convex ring 23 can extend to the upper and lower sides of the outer edge of the deformed peripheral part 21. By providing the reinforced convex ring 23, the outer edge position of the deformed peripheral part 21 has a higher strength. After the deformed peripheral part 21 completes the upward deformation of the rim of the bowl, the reinforcing convex ring 23 can ensure that the blocking lid 2 maintains the current shape without external force. Moreover, due to the existence of the reinforced convex ring 23, when the deformed peripheral part 21 is in a deformation tendency, the pressure of the air storage space is relatively high. The pressure impacts an area of the reinforced convex ring 23 and the deformed peripheral part 21. At this time, the reinforced convex ring 23 is folded upwards, which can drive the deformed peripheral part 21 to be folded upwards, so that a rapid deformation of the blocking lid changes from the rim of the bowl downwards to upwards is realized.

In order to achieve the same effect, the reinforcing convex ring 23 may not be provided, but the thickness of the deformed peripheral part 21 is gradually increased from the central part to the edge, the strength of the position near the outer edge of the deformed peripheral part 21 is made higher, so that the position of the deformed peripheral part 21 near the outer edge is equivalent to the reinforced convex ring 23. It is also possible to ensure that the current shape is maintained without external force after the deformed peripheral portion 21 completes the upward deformation of the rim of the bowl, and the rapid deformation of the blocking lid changes from the rim of the bowl downwards to upwards is realized.

Similarly, as an improvement of the above solution, a lower end of the connecting pillar 24 is provided with a retaining ring 241. The retaining ring 241 is integrally formed with the connecting pillar 24. The diameter of the retaining ring 241 is larger than the diameter of the connecting hole 121. If the lower end of the connecting pillar 24 is provided with the retaining ring 241, even if the connecting pillar 24 of the blocking lid 2 is not in an interference fit with the connecting hole 121, the retaining ring 241 against an edge of the hole of the lower end of the connecting hole 121 can also ensure that the connecting pillar 24 does not easily slip out of the connecting hole 121, thereby improving the stability of the connection between the blocking lid 2 and the exhaust seat 12. If the connecting pillar 24 needs to be pulled out from the connecting hole 121, since the connecting pillar 24 and the retaining ring 241 have certain compression and denaturation characteristics, the retaining ring 241 can be deformed by squeezing it to pass through the connecting hole 121 to pull the connecting pillar 24 out of the connecting hole 121.

The following further introduces the use principle of the automatic spill-proof lid of the embodiments.

Before use, first insert the blocking lid 2 into the connecting hole 121 of the exhaust seat 12 through the connecting pillar 24 to connect with the pot lid 1, and manually press the deformed periphery portion 21 of the blocking lid 2 so that the rim of the bowl of the blocking lid 2 faces downwards. At this time, the edge of the blocking lid 2 is attached to the upper surface of the main body 10 of the pot lid to form a closed air storage space, and all the exhaust ports 11 are all located in the area covered by the blocking lid 2. The spill-proof lid is placed on the position of the rim of the pot, and the snap ring 13 of the rim of the pot on the lower side of the main body 10 of the pot lid is matched with the rim of the pot. At this time, the inside of the pot is in a sealed state.

When cooking in the pot, the blocking lid 2 completely covers the exhaust ports 11 so that the inside of the pot is in a closed state. Even if the food in the pot generates airflow due to heating, the small airflow cannot make the deformed peripheral part 21 of the blocking lid 2 reach an open state. At this time, the airflow circulates in the pot to achieve the effect of heat preservation, accelerate the cooking of the food and reach a boiling state, as shown in FIG. 1 and FIG. 2.

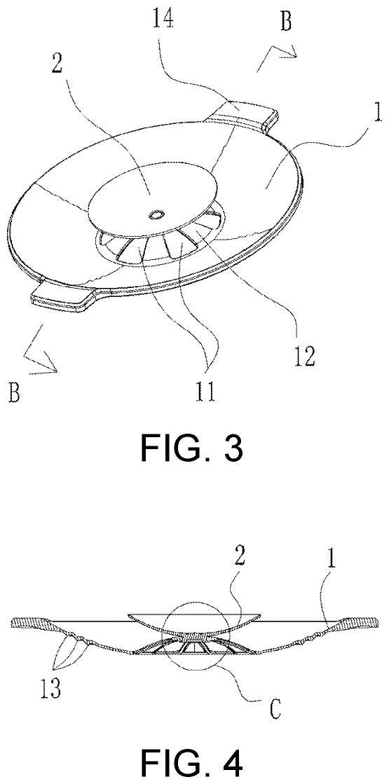

When the food boils, especially when the liquid in the pot is boiling, the bubbles and liquid in the pot rise and are discharged into the air storage space through the exhaust ports 11 of the pot lid 1, so that the air pressure in the air storage space gradually increases. The air pressure on the inner surface of the deformed peripheral part 21 also gradually increases. When the air pressure in the air storage space reaches a certain level, at this time, since the strength of the deformed peripheral part 21 is the smallest, at this time, the deformed peripheral part 21 of the blocking lid 2 is first subjected to the impact of air pressure and has a tendency to fold upwards and deform. As the air pressure in the air storage space continues to increase, the air pressure in the air storage space is greater than the air pressure that the deformed peripheral part 21 bears. The deformed peripheral part 21 will automatically deform from the rim of the bowl downward to upward under the action of the pressure. The blocking lid 2 keeps the rim of the bowl facing upwards, as shown in FIG. 3 and FIG. 4. At this time, the air storage space is greatly opened, and the convection space between the outside air and the exhaust port 11 increases, and the boiling liquid and bubbles can have sufficient space to complete the cold and heat exchange with the outside cold air. The bubbles attached to the exhaust space are condensed into liquid and slide down the inclined surface of the pot lid 1 and flow back into the pot from the exhaust ports 11 to avoid the risk of bubbles and liquid spill out caused by excessive boiling. The whole process does not need to manually operate the blocking lid 2. It will not cause the risk of being scalded by steam and boiling liquid. At the same time, even if there is no guard, there will be no problem of liquid and bubbles spilling out of the pot. When it is necessary to add seasonings to the pot, the seasonings can be added directly through the exhaust ports 11, which is easy to operate.

Since the air storage space formed by the blocking lid 2 and the pot lid 1 of the spill-proof lid does not open immediately, it needs to be opened after the air pressure in the pot reaches a certain level, so the cooking time in the boiling state can be relatively extended, making the food easier to reach the ideal state.

This embodiment also proposes another solution for the connection of the blocking lid 2 and the exhaust seat 12, that is, the blocking lid 2 is provided with a connecting snap hole in the central part corresponding to the non-deformed central part 20. A connecting strip is provided in the central of the top of the exhaust seat 12, and the upper end of the connecting strip is provided with two retaining rings at a certain distance. The distance between the two snap rings is equal to or slightly smaller than the thickness of the non-deformed central part 20, and the diameter of the snap ring is greater than the diameter of the connecting snap hole 121. The upper end of the connecting strip is sleeved into the connecting snap hole of the blocking lid 2, and the two snap rings are respectively located at the edge of the hole at both ends of the connecting snap hole, so that the blocking lid 2 is connected to the upper end of the connecting strip.

Of course, the non-deformed central part 20 can be a point, which is equivalent to the entire blocking lid 2 being the deformed peripheral part 21, and then the connecting pillar 24 or the connecting snap hole can be provided in the central position of the deformed peripheral part 21. This solution can also achieve the upward and downward deformation of the rim of the bowl of the blocking lid 2.

The above are only relatively preferred embodiments of the present invention, and do not constitute a limitation on the scope of protection of the present invention. Any modifications, equivalent replacements and improvements made within the spirit and principles of the present invention shall be included in the protection scope of the claims of the present invention.

What is claimed is:

1. An automatic spill-proof lid, comprising a pot lid (1) and a blocking lid (2), the pot lid (1) is provided with exhaust ports (11), the blocking lid (2) is provided on an upper side of the pot lid (1) corresponding to the exhaust ports (11), wherein the blocking lid (2) is connected to the pot lid (1), and an air storage space is formed between the blocking lid (2) and the pot lid (1); when in use, the blocking lid (2) is deformed by an impact of air pressure discharged from the exhaust ports (11), so that a passage connecting the air storage space between the blocking lid (2) and the pot lid (1) to outside becomes larger.

2. The automatic spill-proof lid according to claim 1, wherein the blocking lid (2) is connected to a central part of the pot lid (1), the exhaust ports (11) are provided in a surrounding area of the pot lid (1) corresponding to a connecting part of the blocking lid (2) and the pot lid (1), and the blocking lid (2) is located above all the exhaust ports (11).

3. The automatic spill-proof lid according to claim 2, wherein the pot lid (1) comprises a main body (10) of the pot lid and an exhaust seat (12), the exhaust seat (12) is provided in a central part of the main body (10) of the pot lid, and a height of the exhaust seat (12) increases from an edge to a central part; a central part of the blocking lid (2) is connected to the central part of the exhaust seat (12), and the exhaust ports (11) are provided on the exhaust seat (12) in the surrounding area corresponding to the connection part of the blocking lid (2) and the exhaust seat (12).

4. The automatic spill-proof lid according to claim 3, wherein the main body (10) of the pot lid is a concave ring structure whose height decreases from an outer edge to the central part, a lower edge of the exhaust seat (12) is connected to an inner edge of the main body (10) of the pot lid, and all the exhaust ports (11) extend to a lowest position of the main body (10) of the pot lid.

5. The automatic spill-proof lid according to claim 4, wherein the exhaust ports (11) are evenly distributed on the exhaust seat (12).

6. The automatic spill-proof lid according to claim 3, wherein a bottom surface of the main body (10) of the pot lid is provided with a plurality of snap rings (13) of a rim of a pot with different diameters.

7. The automatic spill-proof lid according to claim 3, wherein the blocking lid (2) is a bowl-shaped structure, and the central part of the blocking lid (2) and the central part of the exhaust seat (12) are detachably connected; when the blocking lid (2) is impacted by the air pressure discharged from the exhaust ports (11), a rim of a bowl of the blocking lid (2) is changed from facing downwards to facing upwards, resulting in a distance between an edge of the blocking lid (2) and the main body (10) of the pot lid becomes larger, so that the passage connecting the air storage space between the blocking lid (2) and the pot lid (1) to outside becomes larger.

8. The automatic spill-proof lid according to claim 7, wherein when the rim of the bowl of the blocking lid (2) is facing downwards, the edge of the blocking lid (2) is in contact with an upper side of the main body (10) of the pot lid, and all the exhaust ports (11) are located in an area directly under the blocking lid (2).

9. The automatic spill-proof lid according to claim 7, wherein the blocking lid (2) comprises a non-deformed central part (20) and a deformed peripheral part (21) located around the non-deformed central part (20), and a connecting part between the non-deformed central part (20) and the deformed peripheral part (21) is provided with a groove.

10. The automatic spill-proof lid according to claim 7, wherein the blocking lid (2) comprises a non-deformed central part (20) and a deformed peripheral part (21) located around the non-deformed central part (20), and an outer edge of the deformed peripheral part (21) has a reinforced convex ring (23).

11. The automatic spill-proof lid according to claim 7, wherein the blocking lid (2) comprises a non-deformed central part (20) and a deformed peripheral part (21) located around the non-deformed central part (20), and a thickness of the deformed peripheral part (21) gradually increases from a central part to an edge.

12. The automatic spill-proof lid according to claim 7, wherein a central part of a lower side of the blocking lid (2) is provided with a connecting pillar (24), the central part of the exhaust seat (12) is provided with a connecting hole (121) cooperating with the connecting pillar (24), and the blocking lid (2) is inserted into the connection hole (121) of the exhaust seat (12) through the connection pillar (24).

13. The automatic spill-proof lid according to claim 12, wherein a retaining ring (241) is provided at a lower end of the connecting pillar (24), and a diameter of the retaining ring (241) is larger than a diameter of the connecting hole (121).

14. The automatic spill-proof lid according to claim 12, wherein a handle is also provided on the upper side of the blocking lid (2).

15. The automatic spill-proof lid according to claim 7, wherein the central part of the exhaust seat (12) is provided with a connecting strip, and an upper end of the connecting strip is connected to the central part of the blocking lid (2).

16. The automatic spill-proof lid according to claim 15, wherein a connecting snap hole is provided in the central part of the blocking lid (2), the upper end of the connecting strip is provided with two snap rings at a certain distance, diameters of the snap rings are larger than a diameter of the connecting snap hole, the upper end of the connecting strip is sleeved into the connecting snap hole, and the two snap rings are respectively located at the edges of the holes at both ends of the connecting snap hole.

17. The automatic spill-proof lid according to claim 4, wherein the blocking lid (2) is a bowl-shaped structure, and the central part of the blocking lid (2) and the central part of the exhaust seat (12) are detachably connected; when the blocking lid (2) is impacted by the air pressure discharged from the exhaust ports (11), a rim of a bowl of the blocking lid (2) is changed from facing downwards to facing upwards, resulting in a distance between an edge of the blocking lid (2) and the main body (10) of the pot lid becomes larger, so that the passage connecting the air storage space between the blocking lid (2) and the pot lid (1) to outside becomes larger.

18. The automatic spill-proof lid according to claim 5, wherein the blocking lid (2) is a bowl-shaped structure, and the central part of the blocking lid (2) and the central part of the exhaust seat (12) are detachably connected; when the blocking lid (2) is impacted by the air pressure discharged from the exhaust ports (11), a rim of a bowl of the blocking lid (2) is changed from facing downwards to facing upwards, resulting in a distance between an edge of the blocking lid (2) and the main body (10) of the pot lid becomes larger, so that the passage connecting the air storage space between the blocking lid (2) and the pot lid (1) to outside becomes larger.

19. The automatic spill-proof lid according to claim 6, wherein the blocking lid (2) is a bowl-shaped structure, and the central part of the blocking lid (2) and the central part of the exhaust seat (12) are detachably connected; when the blocking lid (2) is impacted by the air pressure discharged from the exhaust ports (11), a rim of a bowl of the blocking lid (2) is changed from facing downwards to facing upwards, resulting in a distance between an edge of the blocking lid (2) and the main body (10) of the pot lid becomes larger, so that the passage connecting the air storage space between the blocking lid (2) and the pot lid (1) to outside becomes larger.
